(19) United States
(12) Patent Application Publication
(10) Pub. No.: US 2023/0192078 A1
(43) Pub. Date: Jun. 22, 2023

(54) METHOD FOR CALCULATING RISK DOMAIN OF VEHICLE-PEDESTRIAN COLLISION AND SAFETY EVALUATION SYSTEM

(71) Applicant: TSINGHUA UNIVERSITY, Beijing (CN)

(72) Inventors: BING-BING NIE, Beijing (CN); QUAN LI, Beijing (CN); SHUN GAN, Beijing (CN); SHENG-BO LI, Beijing (CN)

(21) Appl. No.: 17/920,805

(22) PCT Filed: May 19, 2020
(86) PCT No.: PCT/CN2020/091061

§ 371 Date: Dec. 19, 2022

(30) Foreign Application Priority Data
Apr. 27, 2020 (CN) 202010344141.0

(51) Int. Cl. B60W 30/095; B60W 30/09; B60W 40/02

(52) U.S. Cl. CPC B60W 30/0956; B60W 30/0953; B60W 30/09; B60W 40/02; B60W 2554/4029; B60W 2554/80

(57) ABSTRACT

The present disclosure relates to a method for calculating a hazard zone of vehicle-pedestrian collision and a safety evaluation system. The method for determining the hazard zone of vehicle-pedestrian collision includes: detecting and outputting vehicle information and pedestrian information; determining whether the pedestrian notices the vehicle; further assuming that the vehicle makes an immediate reaction or not corresponding to a case that the pedestrian takes the active evasive action and a case that the pedestrian does not take an active evasive action, respectively; and determining the hazard zone of vehicle-pedestrian collision, according to a determination whether the pedestrian takes the active evasive action or not and an assumption whether the vehicle makes the immediate reaction or not. In the method for determining the hazard zone of vehicle-pedestrian collision of the present disclosure, an active evasive ability of the pedestrian and the immediate reaction of the vehicle are considered, which makes an identification of the hazard zone of vehicle-pedestrian collision more complete. In the present disclosure, hazard zones of collision are determined effectively, which may effectively improve safety of the pedestrian and driving comfort of the vehicle during a vehicle-pedestrian interaction.

### RELATED APPLICATION

The present application is a U.S. National Stage of International Application No. PCT/CN2020/091061, filed on May 19, 2020, which claims the priority of Chinese patent application No. 202010344141.0, filed on Apr. 27, 2020, and entitled “Method for Calculating Hazard Zone of Vehicle-Pedestrian Collision and Safety Evaluation System”, the entire contents of which are incorporated herein by reference in their entireties.

### TECHNICAL FIELD

The present disclosure relates to the technical field of automobile safety, and more particularly, to a method for determining a hazard zone of vehicle-pedestrian collision, and an evaluation system.

### BACKGROUND

With the development of autonomous driving technology of automobile, the technology for vehicle safety is becoming more and more mature, such as the current relatively mature automobile active safety technology. At present, there is an autonomous emergency braking system (AEB system) constructed based on the automobile active safety technology. The AEB system mainly includes three modules: an electronic control unit (ECU), a distance measuring module, and a braking module. The core of the distance measuring module includes a microwave radar, a face recognition technology and a video system, and the distance measuring module may provide safety, accurate, real-time images and road condition information of a road ahead. The AEB system may detect dangerous conditions and automatically start an emergency braking function. In a pedestrian detecting module of the AEB system, the vehicle first identifies the pedestrian and then predicts future motions of the pedestrian by defaulting that the pedestrian is in a motionless state or in a state of moving at a uniform speed. However, the actual operating condition is that when the pedestrian finds the vehicle and is in danger, the pedestrian will take an active moving-backwards evasive action or a speeding-up evasive action to avoid the vehicle. Since the active evasive action of the pedestrian is not fully considered in the current AEB system, the identification of the vehicle-pedestrian collision hazard is incomplete.

### SUMMARY

Based on this, it is necessary to provide a method for determining a hazard zone of vehicle-pedestrian collision, and an evaluation system to solve the problem of incomplete identification of the vehicle-pedestrian collision hazard during a traffic operation involving the vehicle and the pedestrian in the conventional art.

The present disclosure provides a method for determining the hazard zone of vehicle-pedestrian collision, including following steps.

Vehicle information and pedestrian information are detected and outputted.

It is determined whether the pedestrian notices the vehicle, if the pedestrian notices the vehicle, the pedestrian takes an active evasive action, and if the pedestrian does not notice the vehicle, the pedestrian walks normally.

It is further assumed that the vehicle makes an immediate reaction or not corresponding to a case that the pedestrian takes the active evasive action and a case that the pedestrian does not take the active evasive action, respectively.

The hazard zone of vehicle-pedestrian collision is determined, according to a determination whether the pedestrian takes the active evasive action or not and an assumption whether the vehicle makes the immediate reaction or not.

The present disclosure provides a method for evaluating vehicle-pedestrian collision hazard, including following steps.

Vehicle information and pedestrian information are detected and outputted.

It is determined whether the pedestrian notices the vehicle, if the pedestrian notices the vehicle, the pedestrian takes an active evasive action, and if the pedestrian does not notice the vehicle, the pedestrian walks normally.

A hazard zone of vehicle-pedestrian collision is determined corresponding to a case that the pedestrian takes the active evasive action and a case that the pedestrian does not take the active evasive action, respectively.

It is determined whether the pedestrian is in a range of the collision hazard zone.

The hazard of vehicle-pedestrian collision is evaluated according to a determination whether the pedestrian is in the range of the collision hazard zone.

The present disclosure provides a system for evaluating a hazard of vehicle-pedestrian collision, including a detecting module, an analyzing and determining module, a computing module, and an evaluating module.

A detecting module is configured to detect vehicle information and pedestrian information.

An analyzing and determining module is connected to the detecting module, and configured to determine whether the pedestrian notices the vehicle, wherein if the pedestrian notices the vehicle, the pedestrian takes an active evasive action, and if the pedestrian does not notice the vehicle, the pedestrian walks normally.

A computing module is connected to the analyzing and determining module, and configured to determine the hazard zone of vehicle-pedestrian collision corresponding to the case that the pedestrian takes the active evasive action and the case that the pedestrian does not take the active evasive action, respectively.

An evaluating module is connected to the computing module, and configured to evaluate the hazard of the vehicle-pedestrian collision according to whether the pedestrian is in the range of the collision hazard zone.

The present disclosure provides the method for determining the hazard zone of vehicle-pedestrian collision and the evaluation system. The method for determining the hazard zone of vehicle-pedestrian collision includes: detecting and outputting vehicle information and pedestrian information; determining whether the pedestrian notices the vehicle, if the pedestrian notices the vehicle, the pedestrian taking an active evasive action, and if the pedestrian does not notice the vehicle, the pedestrian walking normally; further assuming that the vehicle makes an immediate reaction or not corresponding to a case that the pedestrian takes the active evasive action and a case that the pedestrian does not take the active evasive action, respectively; and determining the hazard zone of vehicle-pedestrian collision, according to a determination whether the pedestrian takes the active evasive action or not and an assumption whether the vehicle makes the immediate reaction or not. In the method for determining the hazard zone of vehicle-pedestrian collision of the present disclosure, the active evasive ability of the pedestrian and the immediate reaction of the vehicle are considered, which makes the identification of the hazard zone of vehicle-pedestrian collision more complete. In the present disclosure, the hazard zones of collision are determined effectively, which may effectively improve the safety of the pedestrian and the driving comfort of the vehicle during the vehicle-pedestrian interaction.

### BRIEF DESCRIPTION OF THE DRAWINGS

In order to illustrate the technical solutions of the embodiments of the present disclosure or the conventional art more clearly, the accompanying drawings required for describing the embodiments or the conventional art will be introduced briefly. It is obvious that the accompanying drawings in the following description are merely some embodiments of the present disclosure, and other drawings may be obtained by those skilled in the art with reference to the accompanying drawings without involving any inventive effort.

FIG. 1 is a schematic view showing an operating state of a vehicle and a pedestrian in a road traffic according to an embodiment of the present disclosure;

FIG. 2 is a flow chart of steps of a method for determining a hazard zone of vehicle-pedestrian collision according to an embodiment of the present disclosure;

FIG. 3 is a flow chart of the method for determining the hazard zone of vehicle-pedestrian collision according to an embodiment of the present disclosure;

FIG. 4 is a view showing kinematic features of the pedestrian during an emergency-stop and moving-backwards evasion for a collision danger according to an embodiment of the present disclosure;

FIG. 5 is a view showing the kinematic features of the pedestrian during a speeding-up evasion for the collision danger according to an embodiment of the present disclosure;

FIG. 6 is a schematic view showing a TTC boundary of the pedestrian moving-backwards evasion, a TTC boundary of the pedestrian moving-forward evasion, and a zone of an inevitable vehicle-pedestrian collision according to an embodiment of the present disclosure;

FIG. 7 is a schematic view showing hazard zones of vehicle-pedestrian collision under a given operating condition according to an embodiment of the present disclosure;

FIG. 8 is a schematic view of a method for evaluating a hazard of vehicle-pedestrian collision according to an embodiment of the present disclosure;

FIG. 9 is a schematic view showing an evaluation system for a vehicle-pedestrian collision hazard according to an embodiment of the present disclosure.

### REFERENCE NUMERALS

evaluation system for vehicle-pedestrian collision hazard 100

detecting module 10

analyzing and determining module 20

computing module 30

evaluating module 40

### DETAILED DESCRIPTION OF THE EMBODIMENTS

In order to facilitate an understanding for the present disclosure, the present disclosure will be described more fully hereinafter with reference to the accompanying drawings. The accompanying drawings are preferred embodiments of the present disclosure. However, the present disclosure may be implemented in various forms and is not limited to the embodiments described herein. On the contrary, these embodiments are provided for a more thorough understanding for the present disclosure.

It should be noted that, when an element is defined to be “fixed to” another element, the element may be directly disposed on the other element or there may be an intermediate element therebetween. When an element is defined to be “connected to” another element, it may be directly connected to the other element, or there may be an intermediate element therebetween as well. The terms “vertical”, “horizontal”, “left”, “right”, and the like, are used for illustrating only, but are not intended to indicate they are the only one embodiment, respectively.

Unless defined otherwise, all technical and scientific terms used herein have the same meanings as commonly understood by the ordinary skill in the art to which the present disclosure belongs. The terminologies in the specification of the present disclosure are used for describing specific embodiments only, but are not intended to limit the present disclosure.

The present disclosure relates to the field of automobile safety, and provides a method for determining a collision hazard zone during a vehicle-pedestrian interaction based on active evasive abilities of the vehicle and the pedestrian. In the method, it is calculated and determined in real time whether the pedestrian is in a hazard zone in which the vehicle drives, to predict the hazard of the vehicle-pedestrian collision. Compared with a traditional estimation/evaluation method for collision, a more accurate hazard zone of vehicle-pedestrian interactive collision may be obtained, which provides a basis for a hazard determination and a strategy-making behaviour of an autonomous driving vehicle.

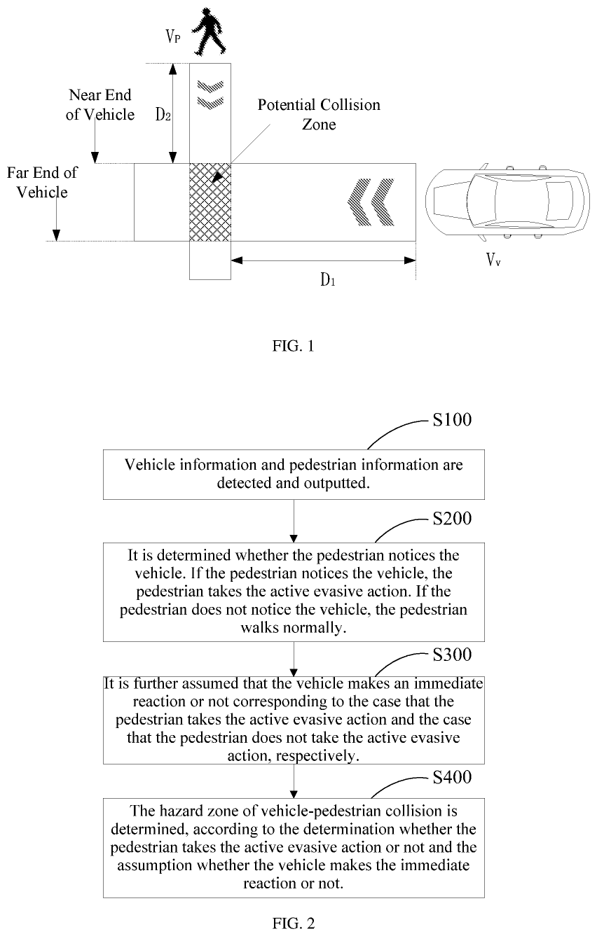

As road traffic participants, the vehicle and the pedestrian will interact and conflict in the process of using a road. Affected by inertia during the motions of the vehicle and the pedestrian, the motion states of the vehicle and the pedestrian cannot be controlled instantaneously to avoid a collision when a dangerous condition occurs. Therefore, within a certain time and space range of the vehicle-pedestrian interaction, a direct vehicle-pedestrian collision is inevitable. A zone of a vehicle-pedestrian relative position, in which there is a collision hazard, is defined as a hazard zone of vehicle-pedestrian collision. As shown in FIG. 1, a potential collision zone in FIG. 1 may be defined as the hazard zone of vehicle-pedestrian collision. To make the present disclosure understood, another concept that should be understood is a time to collision (TTC for short). The TTC is a parameter widely used in evaluating a collision hazard of a vehicle, and it usually refers to the time to the collision of the vehicle, and is obtained by a ratio of a relative distance between the vehicle and the dangerous position to a current vehicle speed. Specifically, the TTC is calculated in the vehicle-pedestrian interaction scene shown in FIG. 1. TTCᵥ denotes the time taken for the vehicle to reach the potential collision zone, and is calculated by TTCᵥ=D₁/νᵥ, where νᵥ denotes a transversal moving speed of the vehicle. TTCₚ denotes a shortest time taken for the pedestrian to avoid the collision, and is calculated by TTCₚ=D₂/νₚ, where νₚ denotes a longitudinal moving speed of the pedestrian, whose direction is perpendicular to the driving direction of the vehicle.

It is assumed that the vehicle is equipped with an in-vehicle sensing system. The in-vehicle sensing system includes various sensors, such as a visual perception module, a millimetre-wave radar, an ultrasonic radar, and a surround view system of 360 degrees, and so on. The synergy between multi-source sensors may identify obstacles such as road lane lines, pedestrians, and vehicles, etc., to ensure a safe driving. The advanced in-vehicle perception system may identify the pedestrian information within a certain range, which includes speed, position, view direction of the pedestrian, etc., to provide information support for determining the collision hazard of the vehicle and making a control decision.

In the present disclosure, the evasive ability of the pedestrian during the traffic operation is considered. The evasive ability of the pedestrian refers to the ability of the pedestrian to take an active evasive action when the pedestrian finds a danger. According to traffic accident investigations and test results, the evasive ability of the pedestrian may reduce the hazard of dangerous accidents when the pedestrian is encountering a danger. Therefore, in the present disclosure, based on results of the test conducted by the inventors, the speed of the pedestrian during the evasion is quantified and defined as the evasive ability of the pedestrian.

Referring to FIG. 2, FIG. 2 provides a method for determining a hazard zone of vehicle-pedestrian collision for the present disclosure.

The method for determining the hazard zone of vehicle-pedestrian collision includes following steps.

At step S100, vehicle information and pedestrian information are detected and outputted. The vehicle information includes: a position of the vehicle, a speed of the vehicle, a driving direction of the vehicle, a maximum braking deceleration of the vehicle, and a maximum lateral acceleration of the vehicle. The pedestrian information includes: a position of the pedestrian, a speed of the pedestrian, a moving direction of the pedestrian, and a view direction of the pedestrian. Both the vehicle information and the pedestrian information may be obtained by the in-vehicle sensing system.

At step S200, it is determined whether the pedestrian notices the vehicle. At this step, the activation of the pedestrian's evasive ability depends on the view direction of the pedestrian. If the approaching vehicle is focused on in the view direction of the pedestrian, it is determined that the pedestrian's evasive ability is activated. If the approaching vehicle is not focused on in the view direction of the pedestrian, it is determined that the pedestrian's evasive ability has not been activated, and the pedestrian continues to maintain a normal motion. If the pedestrian notices the vehicle, the pedestrian takes the active evasive action. If the pedestrian does not notice the vehicle, the pedestrian walks normally. In an embodiment, the active evasive action taken by the pedestrian includes an emergency-stop and moving-backwards evasion or a speeding-up and moving-forward evasion. Of course, based on the core inventive concept of the present disclosure, more evasive actions of the pedestrian may be incorporated to the solutions to determine a more accurate collision hazard zone.

At step S300, it is further assumed that the vehicle makes an immediate reaction or not corresponding to the case that the pedestrian takes the active evasive action and the case that the pedestrian does not take the active evasive action, respectively. At this step, the immediate reaction made by the vehicle includes but is not limited to a normal driving, an emergency braking, or an emergency veering. For example, the immediate reaction made by the vehicle may also include deceleration and braking by means of other facilities on the road.

At step S400, the hazard zone of vehicle-pedestrian collision is determined, according to the determination whether the pedestrian takes the active evasive action or not and the assumption whether the vehicle makes the immediate reaction or not. At this step, the hazard zones of vehicle-pedestrian collision are different corresponding to the case that the pedestrian takes the active evasive action or not, and the case that the vehicle makes the immediate reaction or not. It may be understood that the hazard zone of vehicle-pedestrian collision will be even smaller in the case that the pedestrian takes the active evasive action and the vehicle makes the immediate reaction.

In this embodiment, firstly, the vehicle information and the pedestrian information are detected by the in-vehicle detection system. Further, it is determined whether the pedestrian takes the active evasive action and whether the vehicle makes the immediate reaction. The hazard zones of vehicle-pedestrian collision are calculated corresponding to different cases, respectively. In this embodiment of the method for determining the hazard zone of vehicle-pedestrian collision, the active evasive ability of the pedestrian and the immediate reaction of the vehicle are considered, which makes the identification of the hazard zone of vehicle-pedestrian collision more complete. In the present disclosure, hazard zones of collision are determined effectively in different cases, which may effectively improve the safety of the pedestrian and the driving comfort of the vehicle during the vehicle-pedestrian interaction. By determining whether the pedestrian notices the vehicle, the effective evasive actions of the pedestrian facing dangerous conditions may be classified and quantified. In addition, the embodiment of identifying the collision hazard zone during the vehicle-pedestrian interaction based on the active evasive action of the pedestrian is of great significance to improve the safety of an autonomous vehicle.

In an embodiment of the method for determining the hazard zone of vehicle-pedestrian collision, the active evasive action taken by the pedestrian includes an emergency-stop and moving-backwards evasion or a speeding-up evasion.

The step S400 of determining the hazard zone of vehicle-pedestrian collision according to the determination whether the pedestrian takes the active evasive action or not and the assumption whether the vehicle makes the immediate reaction or not, includes following steps.

At step S410, in the case that the pedestrian takes the active evasive action, time safety boundaries when the vehicle and the pedestrian reach a potential collision point are calculated, respectively, and the time safety boundary is a TTC safe envelope line. At step S420, on the basis of the TTC safe envelope lines, the hazard zone of vehicle-pedestrian collision is further determined.

In this embodiment, what obtained are the TTC safe envelope lines of the vehicle-pedestrian collision in the case that the evasive ability of the vehicle is not considered, and that the pedestrian takes the active evasive action. In the present disclosure, if necessary, the TTC safe envelope lines of the vehicle-pedestrian collision may be obtained in the case that the evasive ability of the vehicle is considered and the pedestrian takes the active evasive action.

In an embodiment, the step of determining the TTC safe envelope lines of the vehicle-pedestrian collision includes following steps.

At step S411, a distance range detected by the vehicle is determined. At this step, the distance range detected by the vehicle may be detected and obtained by the in-vehicle detection system.

At step S412, a shortest distance required for the pedestrian to safely evade the vehicle is calculated according to an emergency-stop and moving-backwards evasion speed of the pedestrian, a speeding-up evasion speed of the pedestrian, and a vehicle width. At this step, calculations are performed corresponding to two cases. The shortest distance required for the pedestrian to safely evade the vehicle, which is calculated according to the emergency-stop and moving-backwards evasion speed of the pedestrian and the vehicle width, is a first distance. The shortest distance required for the pedestrian to safely evade the vehicle, which is calculated according to the speeding-up evasion speed of the pedestrian and the vehicle width, is a second distance.

At step S413, the TTC safety boundaries of the pedestrian are calculated according to an initial speed of the pedestrian and the shortest distance required for the pedestrian to evade the vehicle safely. According to the initial speed of the pedestrian combining with the first distance and the second distance calculated at the step S412 above, the first safety boundary and the second safety boundary of the TTC of the pedestrian are calculated respectively. The first safety boundary and the second safety boundary are the TTC safety boundaries.

At step S414, the TTC safe envelope lines of the vehicle-pedestrian collision hazard are calculated according to the TTC of the vehicle and the TTC safety boundaries of the pedestrian. At this step, the TTC safe envelope lines of the vehicle-pedestrian collision hazard are determined according to the first safety boundary, the second safety boundary and the range of the TTC of the vehicle-pedestrian collision.

In this embodiment, what provided are specific steps of determining or calculating the TTC safe envelope range in the case of the active evasive ability of the pedestrian without considering the evasive ability of the vehicle. Of course, specific steps of determining or calculating the TTC safe envelope range in the case of the active evasive ability of the pedestrian considering the evasive ability of the vehicle may also be provided.

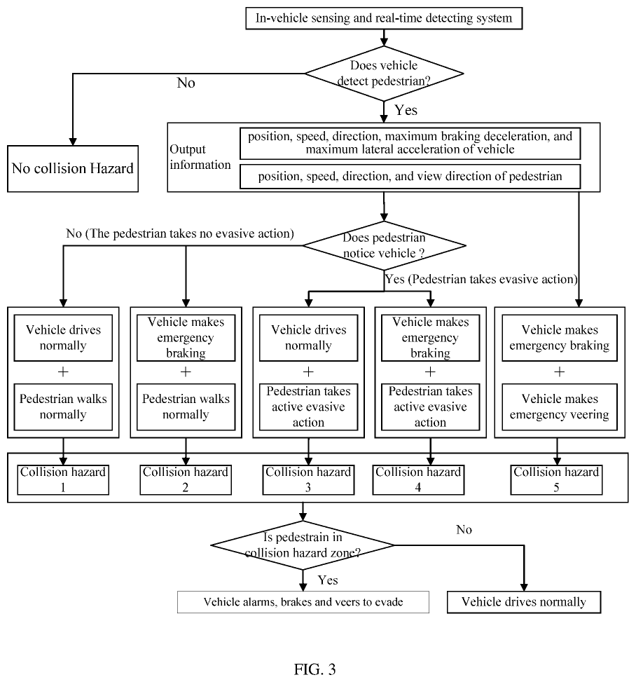

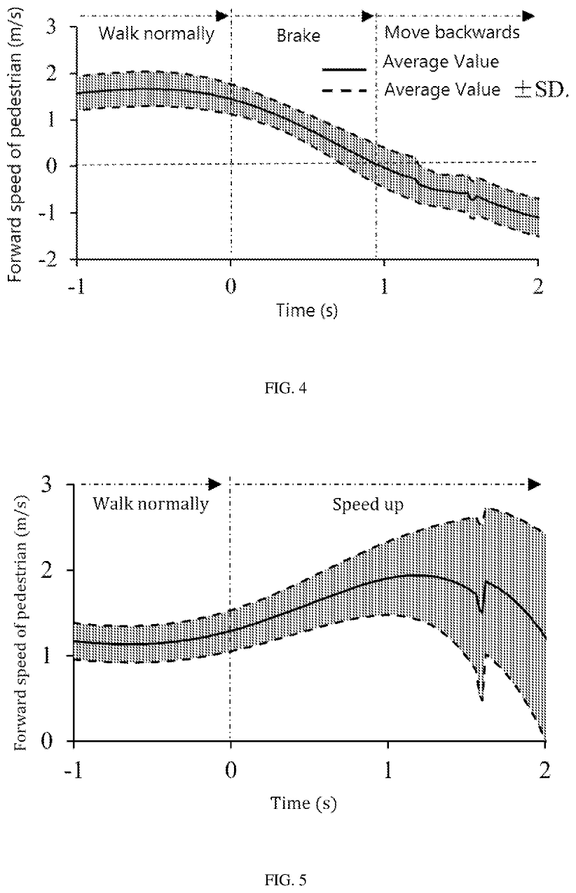

Referring to FIG. 3, a flow chart of generating the hazard zone of vehicle-pedestrian collision is provided. The collision hazard zone obtained in FIG. 3 is affected by the reactions of both the vehicle and the pedestrian. The overall method for determining the collision hazard zone is shown in FIG. 3. The in-vehicle perception detection system detects the vehicle information and the pedestrian information. It is determined whether the evasive ability of the pedestrian is activated or not by determining whether the pedestrian notices the vehicle. The activation of the evasive ability of the pedestrian may depend on the view direction of the pedestrian. If the view direction of the pedestrian focuses on the approaching vehicle, it is determined that the evasive ability of the pedestrian is activated. If the view direction of the pedestrian does not focus on the approaching vehicle, it is determined that the evasive ability the pedestrian has not been activated yet, and the pedestrian continues to maintain the normal motion. According to current researches on pedestrian's traffic behaviours, the effective evasive action of the pedestrian facing a danger is an immediate moving-backwards evasion or an immediate speeding-up evasion. Therefore, based on experiments on pedestrian volunteers in quasi-real traffic scenes, the inventors of the present disclosure got the emergency-stop and moving-backwards evasion speed (ν_{pb}) of the pedestrian and the speeding-up evasion speed (ν_{pf}) of the pedestrian in the case that the pedestrians facing dangerous conditions take evasive actions. For the specific test data, please refer to FIGS. 4 and 5. FIG. 4 shows the kinematic features of the pedestrian during the emergency-stop and moving-backwards evasion for the collision danger, and a time instant t=0 represents the moment that the pedestrian starts to take the evasive action. FIG. 5 shows the kinematic features of the pedestrian during the speeding-up evasion for the collision danger, and the time instant t=0 represents the moment that the pedestrian starts to take the evasive action.

In an embodiment, at the steps S411 to S414, the TTC safe envelope lines of the vehicle-pedestrian collision hazard may be calculated according to following formula (1) to formula (7):

$${TTC}_{vr} = \frac{{D}_{vr}}{{v}_{v}} \qquad ( 1 )$$

$$\{ 0 \leq {TTC}_{vd} \leq {TTC}_{vr} \} \qquad ( 2 )$$

$${D}_{pb - ne} ( {TTC}_{vd} ) = {\int }_{0}^{{TTC}_{vd}} {v}_{pb} ( t ) {d}_{TTC} + \frac{{L}_{vw}}{2} \qquad ( 3 )$$

$${D}_{pf - fe} ( {TTC}_{vd} ) = {\int }_{0}^{{TTC}_{vd}} {v}_{pf} ( t ) {d}_{TTC} - \frac{{L}_{vw}}{2} \qquad ( 4 )$$

$${TTC}_{pb - ne} ( {TTC}_{vd} ) = {D}_{pb - ne} ( {TTC}_{vd} ) / {v}_{pw} \qquad ( 5 )$$

$${TTC}_{pf - fe} ( {TTC}_{vd} ) = {D}_{pf - fe} ( {TTC}_{vd} ) / {v}_{pw} \qquad ( 6 )$$

$$[ {TTC}_{vd} , {TTC}_{pf - fe} ] \leq TTCdangerous - area \leq [ {TTC}_{vd} , {TTC}_{pb - ne} ] \qquad ( 7 )$$

In the above equations, ne is an abbreviation of a near end, which means a side of the vehicle proximate to the pedestrian and is referred to the near end. In the above equations, fe is an abbreviation of a far end, which means another side of the vehicle away from the pedestrian and is referred to the far end. Dᵥᵣ represents a longest distance detected by the vehicle. νᵥ represents the driving speed of the vehicle. TTCᵥᵣ represents the time taken for the vehicle driving at the current speed to a farthest detection point. TTC_{vd} represents the time taken for the vehicle to reach a potential collision, and TTC_{vd} is a variable. ν_{pb} represents the emergency-stop and moving-backwards evasion speed of the pedestrian. ν_{pf} represents the speeding-up evasion speed of the pedestrian. D_{pb-ne} represents the shortest distance of the pedestrian away from the near end of the vehicle, which is required for the pedestrian to safely evade the vehicle in the case that the pedestrian takes the emergency-stop and moving-backwards evasive action. TTC_{pf-fe} represents the shortest distance of the pedestrian away from the far end of the vehicle, which is required for the pedestrian to safely evade the vehicle in the case that the pedestrian takes the speeding-up evasive action. L_{vw} represents the width of the vehicle. ν_{pw} represents the initial speed of the pedestrian when the pedestrian starts to take the evasive action. TTC_{pb-ne} represents the shortest time taken for the pedestrian to evade the vehicle in the case that the pedestrian takes the emergency-stop and moving-backwards evasive action. TTC_{pf-ne} represents the shortest time taken for the pedestrian to safely evade the vehicle in the case that the pedestrian takes the speeding-up evasive action. TTCdangerous−area represents the TTC safe envelope lines of the vehicle-pedestrian collision hazard.

A relative safe distance between the vehicle and the pedestrian in the actual traffic scene is calculated by considering whether the active evasive actions thereof are activated or not when the pedestrian and the vehicle are in dangerous conditions. As the interaction process between the vehicle and the pedestrian is dynamic, the vehicle-pedestrian collision hazard depends on information of the vehicle and the pedestrian, such as the moving speeds, the moving directions, and the relative positions of the vehicle and the pedestrian at that time. Therefore, in order to describe the method for determining a two-dimensional hazard zone of the vehicle-pedestrian collision briefly, a known human-vehicle interaction condition is taken as an example to calculate the two-dimensional hazard zone of the vehicle-pedestrian collision under this operating condition. Suppose the operating condition is as follows: the driving speed of the vehicle is νᵥ=60 km/h; the vehicle detects that the pedestrian is in right front of the vehicle and has a walking speed ν_{pd}=1 m/s; the moving directions of the vehicle and the pedestrian are perpendicular to each other; the maximum braking deceleration of the vehicle is aᵥₓ₋ₘₐₓ=−7 m/s², and the maximum lateral acceleration is a_{vy-max}=−6.5 m/s²; and the width of the vehicle is L_{vw}=2 m . The longest distance range detected by the vehicle sensor is Dᵥᵣ=100 m, then the TTC range detected by the vehicle is TTCᵥᵣ=6 s. The equation (2) above may be expressed as: {TTC_{vd}:0≤TTC_{vd}≤6 s}.

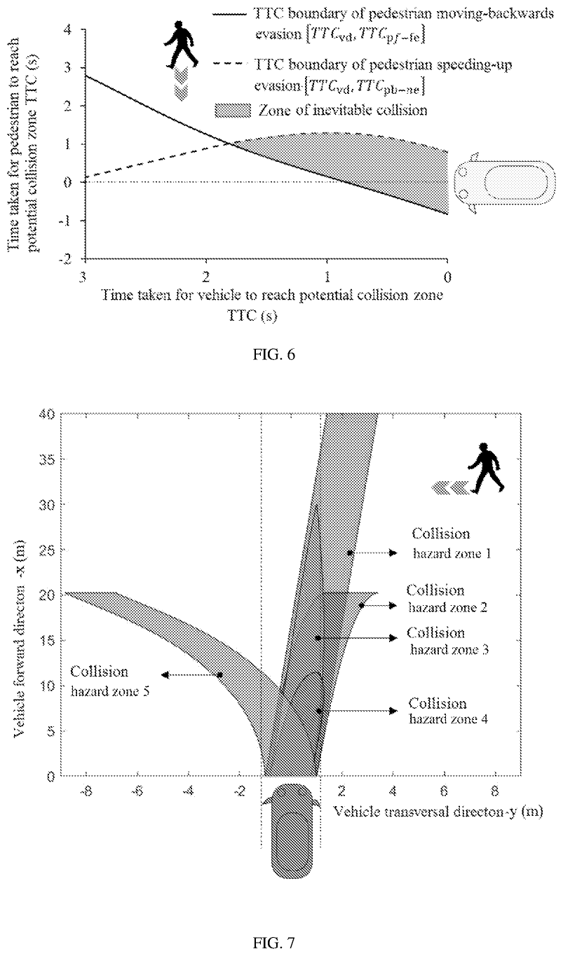

In this embodiment, the TTC safe envelope lines of the vehicle-pedestrian collision hazard are calculated with reference to the above equation (1) to equation (7), as shown in FIG. 6. FIG. 6 shows an inevitable zone (shown by the shaded part of FIG. 6) of vehicle-pedestrian collision through a TTC boundary of the pedestrian moving-backwards evasion, a TTC boundary of the pedestrian moving-forwards evasion.

In an embodiment, the step S400 of determining the hazard zone of vehicle-pedestrian collision according to the determination whether the pedestrian takes the active evasive action or not and the assumption whether the vehicle makes the immediate reaction or not, includes following steps.

Firstly, a first hazard zone is determined in the case that neither the pedestrian takes an active evasive action nor the vehicle makes an immediate reaction.

In an embodiment, in the case that neither the pedestrian takes the active evasive action nor the vehicle makes the immediate reaction, the first collision hazard zone is determined to be: [Dᵥ₋₁, D_{p-1-fe}]≤the first collision hazard zone≤[Dᵥ₋₁, Dₚ₋₁₋ₙₑ] according to the following equations (11) to (13):

$${D}_{v - 1} ( {TTC}_{vd} ) = {\int }_{0}^{{TTC}_{vd}} {v}_{v} {d}_{TTC} \qquad ( 11 )$$

$${D}_{p - 1 - ne} ( {TTC}_{vd} ) = {v}_{pd} \times {TTC}_{vd} + \frac{{L}_{vw}}{2} \qquad ( 12 )$$

$${D}_{p - 1 - fe} ( {TTC}_{vd} ) = {v}_{pd} \times {TTC}_{vd} - \frac{{L}_{vw}}{2} \qquad ( 13 )$$

Where, νᵥ represents the current driving speed of the vehicle. TTC_{vd} represents the time taken for the vehicle to reach the potential collision point. ν_{pd} represents the current moving speed of the pedestrian detected by the vehicle in the actual motion scene. Dᵥ₋₁ represents the first traveled range of the vehicle in the driving direction within the time TTC_{vd}. L_{vw} represents the width of the vehicle. Dₚ₋₁₋ₙₑ represents the first shortest distance of the pedestrian away from the near end of the vehicle, which is required for the pedestrian to safely evade the vehicle when the pedestrian moves at the speed ν_{pd}. D_{p-1-fe} represents the second shortest distance of the pedestrian away from the far end of the vehicle, which is required for the pedestrian to safely evade the vehicle when the pedestrian moves at the speed ν_{pd}.

Secondly, a second hazard zone is determined in the case that the pedestrian does not take the active evasive action but the vehicle makes an emergency braking.

In an embodiment, in the case that the pedestrian does not take the active evasive action but the vehicle takes emergency braking, the second collision hazard zone is determined to be: [Dᵥ₋₂, D_{p-2-fe}]≤the second collision hazard zone≤[Dᵥ₋₂, Dₚ₋₂₋ₙₑ] according to the following equations (14) to (16):

$${D}_{v - 2} ( {TTC}_{vd} ) = {\int }_{0}^{{v}_{v} / {a}_{vx - max}} {v}_{v} + {a}_{vx - max} \times {TTC}_{vd} {d}_{TTC} \qquad ( 14 )$$

$${D}_{p - 2 - ne} ( {TTC}_{vd} ) = {v}_{pd} \times {TTC}_{vd} + \frac{{L}_{vw}}{2} \qquad ( 15 )$$

$${D}_{p - 2 - fe} ( {TTC}_{vd} ) = {v}_{pd} \times {TTC}_{vd} - \frac{{L}_{vw}}{2} \qquad ( 16 )$$

Where, νᵥ represents the current driving speed of the vehicle. TTC_{vd} represents the time taken for the vehicle to reach the potential collision point. ν_{pd} represents the current moving speed of the pedestrian detected by the vehicle in the actual motion scene. aᵥₓ₋ₘₐₓ represents the maximum braking deceleration of the vehicle. Dᵥ₋₂ represents the second traveled range of the vehicle in the driving direction within the time TTC_{vd}. L_{vw} represents the width of the vehicle. Dₚ₋₂₋ₙₑ represents the third shortest distance of the pedestrian away from the near end of the vehicle, which is required for the pedestrian to safely evade the vehicle when the pedestrian moves at the speed ν_{pd}. D_{p-2-fe} represents the fourth shortest distance of the pedestrian away from the far end of the vehicle, which is required for the pedestrian to safely evade the vehicle when the pedestrian moves at the speed ν_{pd}.

Thirdly, a third hazard zone is determined in the case that the pedestrian takes the active evasive action but the vehicle does not make the immediate reaction.

In an embodiment, in the case that the pedestrian takes the active evasive action but the vehicle does not make the immediate reaction, the third collision hazard zone is determined to be: [Dᵥ₋₃, D_{p-3-BA-ne}]≤the third collision hazard zone≤[Dᵥ₋₃, D_{p-3-FA-fe}] according to the following equations (17) to (19):

$${D}_{v - 3} ( {TTC}_{vd} ) = {\int }_{0}^{{TTC}_{vd}} {v}_{v} {d}_{TTC} \qquad ( 17 )$$

$${D}_{p - 3 - ne} ( {TTC}_{vd} ) = {v}_{pd} ( {TTC}_{vd} ) \times {TTC}_{pb - ne} ( {TTC}_{vd} ) + \frac{{L}_{vw}}{2} \qquad ( 18 )$$

$${D}_{p - 3 - fe} ( {TTC}_{vd} ) = {v}_{pd} ( {TTC}_{vd} ) \times {TTC}_{pf - fe} ( {TTC}_{vd} ) - \frac{{L}_{vw}}{2} \qquad ( 19 )$$

Where, νᵥ represents the current driving speed of vehicle. TTC_{vd} represents the time taken for the vehicle to reach the potential collision point. ν_{pd} represents the current moving speed of the pedestrian detected by the vehicle in the actual motion scene. TTC_{pb-ne} represents the shortest time taken for the pedestrian to evade the vehicle in the case that the pedestrian takes the emergency-stop and moving-backwards evasive action. TTC_{pf-ne} represents the shortest time taken for the pedestrian to safely evade the vehicle in the case that the pedestrian takes the speeding-up evasive action. L_{vw} represents the width of the vehicle. D_{ν-3} represents the third traveled range of the vehicle in the driving direction within the time TTC_{vd}. Dₚ₋₃₋ₙₑ represents the fifth shortest distance of the pedestrian away from the near end of the vehicle, which is required for the pedestrian to safely evade the vehicle when the pedestrian moves at the speed ν_{pd}. D_{p-3-fe} represents the sixth shortest distance of the pedestrian away from the far end of the vehicle, which is required for the pedestrian to safely evade the vehicle when the pedestrian moves at the speed ν_{pd}.

Fourthly, a fourth hazard zone is determined in the case that the pedestrian takes the active evasive action and the vehicle makes an emergency braking.

In an embodiment, in the case that the pedestrian takes the active evasive action and the vehicle makes an emergency braking, the fourth collision hazard zone is determined to be: [Dᵥ₋₄, Dₚ₋₄₋ₙₑ]≤the fourth collision hazard zone≤[Dᵥ₋₄, D_{p-4-fe}] according to the following equations (20) to (22):

$${D}_{v - 4} ( {TTC}_{vd} ) = {\int }_{0}^{{v}_{v} / {a}_{vx - max}} {v}_{v} + {a}_{vx - max} \times {TTC}_{vd} {d}_{TTC} \qquad ( 20 )$$

$${D}_{p - 4 - ne} ( {TTC}_{vd} ) = {v}_{pd} ( {TTC}_{vd} ) \times {TTC}_{pb - ne} ( {TTC}_{vd} ) + \frac{{L}_{vw}}{2} \qquad ( 21 )$$

$${D}_{p - 4 - fe} ( {TTC}_{vd} ) = {v}_{pd} ( {TTC}_{vd} ) \times {TTC}_{pf - fe} ( {TTC}_{vd} ) - \frac{{L}_{vw}}{2} \qquad ( 22 )$$

Where, νᵥ represents the current driving speed of the vehicle. TTC_{vd} represents the time taken for the vehicle to reach the potential collision point. ν_{pd} represents the current moving speed of the pedestrian detected by the vehicle in the actual motion scene. aᵥₓ₋ₘₐₓ represents the maximum braking deceleration of the vehicle. TTC_{pb-ne} represents the shortest time taken for the pedestrian to evade the vehicle in the case that the pedestrian takes the emergency-stop and moving-backwards evasive action. TTC_{pf-ne} represents the shortest time taken for the pedestrian to safely evade the vehicle in the case that the pedestrian takes the speeding-up evasive action. L_{vw} represents the width of the vehicle. Dᵥ₋₄ represents the fourth traveled range of the vehicle in the driving direction within the time TTC_{vd}. Dₚ₋₄₋ₙₑ represents the seventh shortest distance of the pedestrian away from the near end of the vehicle, which is required for the pedestrian to safely evade the vehicle when the pedestrian moves at the speed ν_{pd}. D_{p-4-fe} represents the eighth shortest distance of the pedestrian away from the far end of the vehicle, which is required for the pedestrian to safely evade the vehicle when the pedestrian moves at the speed ν_{pd}.

In an embodiment, after the step of detecting and outputting the vehicle information and the pedestrian information, the method also includes determining the fifth hazard zone in the case that the vehicle makes the emergency braking and makes an emergency veering.

In an embodiment, when the evasive ability of the vehicle is considered, the immediate reaction of the vehicle includes a normal driving of the vehicle and an emergency braking of the vehicle (the emergency braking of the vehicle includes a straight-driving emergency braking and an emergency veering). The braking distance of the vehicle may be determined according to the current driving speed of the vehicle and the maximum braking deceleration of the vehicle. Alternatively, the minimum turning radius of the vehicle may be determined according to the current driving speed of the vehicle and the maximum lateral acceleration of the vehicle.

Specifically, the braking deceleration of the vehicle refers to the vehicle's ability of rapidly reducing the speed of the vehicle in driving until the vehicle stops. The maximum braking deceleration of the vehicle depends on a friction coefficient between the vehicle tire and the ground. In the actual operating condition, the friction coefficient between the ground and the tire is usually 0.6 to 0.8, that is, the braking deceleration of the vehicle is usually 6 m/s² to 8 m/s².

The maximum lateral acceleration of the vehicle, namely the lateral acceleration of the vehicle, refers to an acceleration in the direction perpendicular to the driving direction of the vehicle, namely the acceleration caused by a centrifugal force generated when the vehicle is veering. That is, a trend of being “thrown away” of the vehicle. Theoretically, the greater the acceleration, the easier the vehicle is to be “thrown away” from the driving path. Therefore, the extreme veering performance of the vehicle in driving depends on the maximum lateral acceleration of the vehicle.

In an embodiment, the evasive ability of the vehicle is considered with reference to equation (8) to equation (10). The evasive ability of the vehicle specifically refers to the braking ability and veering ability of the vehicle in driving. The braking ability of the vehicle, namely the brake distance (D_{vb}), depends on the current driving speed (νᵥ) and the maximum braking deceleration (aᵥₓ₋ₘₐₓ) of the vehicle.

D_{vb}=(νᵥ)²/2aᵥₓ₋ₘₐₓ (8)

νᵥ represents the current driving speed of the vehicle, and aᵥₓ₋ₘₐₓ represents the maximum braking deceleration of the vehicle.

The veering ability of the vehicle refers to the minimum turning radius (R_{vd-min}) while the vehicle maintains the stability at the current driving speed, and depends on the current driving speed of the vehicle (νᵥ) and the maximum lateral acceleration (a_{vy-max}).

Rᵥ₋ₘᵢₙ=νᵥ/wᵥ (9)

wᵥ=νᵥ/a_{vy-max},(R_{vd-min}≥Rᵥ₋ₘᵢₙ) (10)

wᵥ represents a yaw velocity of the vehicle. Rᵥ₋ₘᵢₙ represents the minimum turning radius of the vehicle (belonging to a parameter of the vehicle, less than or equal to the minimum turning radius R_{vd-min} maintaining the stability of the vehicle at the current driving speed).

In this embodiment, the evasive ability of the vehicle is considered, and the immediate reaction of the vehicle includes the normal driving of the vehicle and the emergency braking of the vehicle. The emergency braking of the vehicle may include the straight-driving emergency braking and the emergency veering. In this embodiment, the evasive ability of the vehicle is taken into account, so that the determination for the hazard zone of vehicle-pedestrian collision may be more accurate.

In an embodiment, in the case that the vehicle makes the emergency braking and the emergency veering, the fifth hazard zone of the vehicle-pedestrian collision is determined according to the following equations (23) to (28) to be: [Dᵥ₋₅, D_{vl-5-fe}]≤the fifth collision hazard zone≤[D_{V-5}, Dᵥₗ₋₅₋ₙₑ].

$${D}_{v - 5} ( {TTC}_{vd} ) = {\int }_{0}^{{v}_{v} / {a}_{vx - max}} {v}_{v} + {a}_{vx - max} \times {TTC}_{vd} {d}_{TTC} \qquad ( 23 )$$

$${v}_{vb} ( {TTC}_{vd} ) = {v}_{v} + {a}_{vx - max} \times {TTC}_{vd} \qquad ( 24 )$$

$${R}_{vb} ( {TTC}_{vd} ) = {( {v}_{vb} )}^{2} / {a}_{vy - max} \qquad ( 25 )$$

$${A}_{vs} ( {TTC}_{vd} ) = {tan}^{- 1} \sum \frac{Δ {D}_{v - 5}}{{R}_{vb} ( {TTC}_{vd} )} \qquad ( 26 )$$

$${D}_{vl - 5 - ne} ( {TTC}_{vd} ) = {\sum }_{0}^{{TTC}_{vd}} ( Δ {D}_{v - 5} \times sin {A}_{vs} ( {TTC}_{vd} ) ) + \frac{{L}_{vw}}{2} \qquad ( 27 )$$

$${D}_{vl - 5 - fe} ( {TTC}_{vd} ) = {\sum }_{0}^{{TTC}_{vd}} ( Δ {D}_{v - 5} \times sin {A}_{vs} ( {TTC}_{vd} ) ) - \frac{{L}_{vw}}{2} \qquad ( 28 )$$

Where, νᵥ represents the current driving speed of the vehicle. ν_{vb} represents the speed of the vehicle in the process of braking. aᵥₓ₋ₘₐₓ represents the maximum braking deceleration of the vehicle. a_{vy-max} represents the maximum lateral acceleration of the vehicle. TTC_{vd} represents the time taken for the vehicle to reach the potential collision point. Aᵥₛ represents an accumulated turning angle in the process of veering. Dᵥ₋₅ represents the fifth traveled range of the vehicle in the driving direction within the time TTC_{vd}. Dₚ₋₅₋ₙₑ represents the ninth shortest distance of the pedestrian away from the near end of the vehicle, which is required for the pedestrian to safely evade the vehicle when the pedestrian moves at the speed ν_{pd}. D_{p-5-fe} represents the tenth shortest distance of the pedestrian away from the far end of the vehicle, which is required for the pedestrian to safely evade the vehicle when the pedestrian moves at the speed ν_{pd}.

In this embodiment, in the process of calculating the fifth hazard zone, the present disclosure also describes the effectiveness of veering on a hazard reduction. The vehicle facing the dangerous condition usually makes a braking reaction, but cannot judge the collision hazard of braking and veering. In this embodiment, the immediate reaction of the vehicle (including the straight-driving emergency braking and the emergency veering) is considered, and the evasive ability of the vehicle is taken into account, so that the determination of the hazard zone of vehicle-pedestrian collision may be more accurate.

Referring to FIG. 7, FIG. 7 shows a schematic view of hazard zones of vehicle-pedestrian collision. The current operating condition of the vehicle in FIG. 7 is as follows: the driving speed of the vehicle is νᵥ=60 km/h; the vehicle detects that the pedestrian is in right front of the vehicle and has a walking speed ν_{pd}=1 m/s; the moving directions of the vehicle and the pedestrian are perpendicular to each other; the maximum braking deceleration of the vehicle is aᵥₓ₋ₘₐₓ=−7 m/s², and the maximum lateral acceleration is a_{vy-max}=−6.5 m/s²; and the width of the vehicle is L_{vw}=2 m. The longest distance range detected by the vehicle sensor is Dᵥᵣ=100 m, then the TTC range detected by the vehicle is TTCᵥᵣ=6 s. By combining the first collision hazard zone, the second collision hazard zone, the third collision hazard zone, the fourth collision hazard zone and the fifth collision hazard zone obtained in the above embodiments, it is possible to provide the vehicle with a more correct and reasonable execution strategy with a less collision hazard.

A collision hazard zone 1 shown in FIG. 7 is the first collision hazard zone calculated in the above embodiment. A collision hazard zone 2 shown in FIG. 7 is the second collision hazard zone calculated in the above embodiment. A collision hazard zone 3 shown in FIG. 7 is the third collision hazard zone calculated in the above embodiment. A collision hazard zone 4 shown in FIG. 7 is the fourth collision hazard zone calculated in the above embodiment. A collision hazard zone 5 shown in FIG. 7 is the fifth collision hazard zone calculated in the above embodiment. For example, according to the collision hazard zones shown in FIG. 7, the following execution strategy may be provided for the vehicle. Firstly, for the pedestrian located in a remaining hazard zone of the collision hazard zone 1 minus the collision hazard zone 2 and minus the collision hazard zone 3, the vehicle may take the active evasive action (braking or veering) or issue an alarm to remind the pedestrian to pay attention to the vehicle and take the active evasive action to evade collision. Secondly, for the pedestrian located in a remaining hazard zone of the collision hazard zone 2 minus the collision hazard zone 3 and minus the collision hazard zone 4, the vehicle may take the active evasive action (veering) or issue an alarm to remind the pedestrian to pay attention to the vehicle and take the active evasive action to evade collision. Thirdly, for the pedestrian located in a remaining hazard zone of the collision hazard zone 3 minus the collision hazard zone 4, the active evasive action of the pedestrian cannot prevent the collision effectively any more, and the collision can be prevented only by means of the active evasion (braking or veering) of the vehicle. Fourthly, for the pedestrian located in a remaining hazard zone of the collision hazard zone 4 minus the collision hazard zone 5, the active evasive action of the pedestrian cannot prevent the collision effectively any more, and if the vehicle only takes the braking action, the collision still cannot be prevented, and the collision can be prevented only by means of active emergency veering of the vehicle. Fifthly, for the pedestrian located in the common hazard zone of the collision hazard zone 4 and the collision hazard zone 5, any action taken by the pedestrian cannot prevent the collision.

In the description of the present disclosure, the effective evasive actions of the pedestrian facing the dangerous operating condition are classified and quantified. In addition, in the present disclosure, the hazard zone is divided by considering the evasive abilities of the pedestrian and the vehicle comprehensively. In the present disclosure, the identification of the collision hazard zone determined during the vehicle-pedestrian interaction based on the active evasive action of the pedestrian is of great significance for improving the safety of autonomous driving vehicles.

In a specific embodiment, the application scene of the present disclosure involves the vehicle having active detection ability. The vehicle information that can be detected by the vehicle itself includes: the speed, the braking deceleration, and the lateral acceleration of the vehicle, etc. Moreover, the vehicle may identify pedestrians within the detection range, and may detect the position, the speed, the moving direction, and the view direction of the pedestrian. The above information obtained by the vehicle is used as the input, and the evasive abilities of the vehicle and the pedestrian under the dangerous condition are used as calculation parameters, and the collision hazard existing in the vehicle-pedestrian interaction process may be calculated in real time during the driving process of the vehicle.

In an embodiment, the present disclosure also provides a system for determining a hazard zone of vehicle-pedestrian collision. The system for determining the hazard zone of vehicle-pedestrian collision includes: a detecting module, a first analyzing and determining module, a second analyzing and determining module, and a computing module.

The detecting module is configured to detect and output vehicle information and pedestrian information.

The first analyzing and determining module is configured to determine whether the pedestrian notices the vehicle. If the pedestrian notices the vehicle, the pedestrian takes an active evasive action. If the pedestrian does not notice the vehicle, the pedestrian walks normally.

The second analyzing and determining module is configured to further assume that the vehicle makes an immediate reaction or not corresponding to the case that the pedestrian takes the active evasive action and the case that the pedestrian does not take the active evasive action, respectively.

The computing module is configured to determine the hazard zone of vehicle-pedestrian collision according to the determination whether the pedestrian takes the active evasive action or not and the assumption whether the vehicle makes the immediate reaction or not.

In this embodiment of the system for determining the hazard zone of vehicle-pedestrian collision, the active evasive ability of the pedestrian and the immediate reaction of the vehicle are considered, which makes the identification of the hazard zone of vehicle-pedestrian collision more complete. In the present disclosure, hazard zones of collision are determined effectively in different cases, which may effectively improve the safety of the pedestrian and the driving comfort of the vehicle during the vehicle-pedestrian interaction. By determining whether the pedestrian notices the vehicle, the effective evasive actions of the pedestrian facing dangerous conditions may be classified and quantified. In addition, the embodiment of identifying the collision hazard zone during the vehicle-pedestrian interaction based on the active evasive action of the pedestrian is of great significance to improve the safety of an autonomous vehicle.

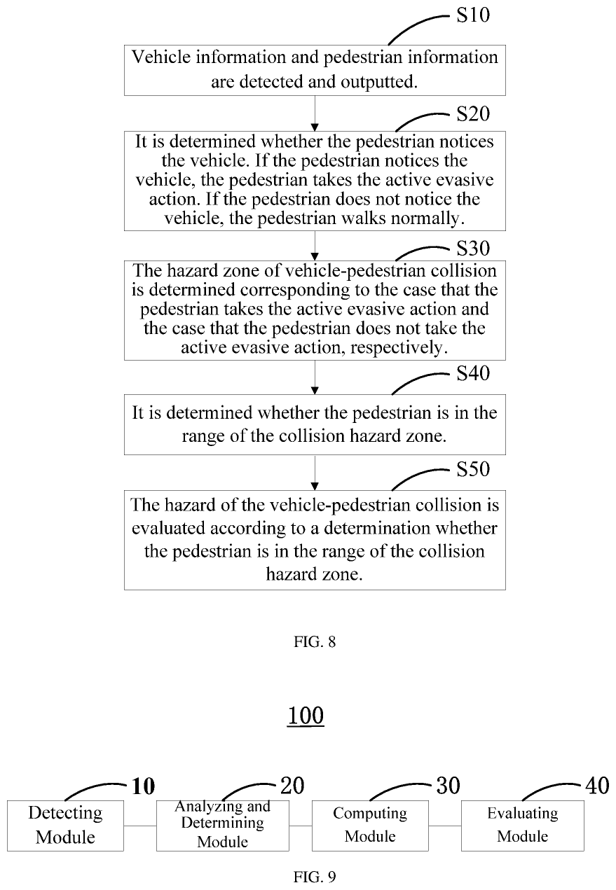

Referring to FIG. 8, the present disclosure provides a method for evaluating a hazard of vehicle-pedestrian collision, which includes following steps.

At step S10, vehicle information and pedestrian information are detected and outputted. The vehicle information includes: a position of the vehicle, a speed of the vehicle, a driving direction of the vehicle, a maximum braking deceleration of the vehicle, and a maximum lateral acceleration of the vehicle. The pedestrian information includes: a position of the pedestrian, a speed of the pedestrian, a moving direction of the pedestrian, and a view direction of the pedestrian.

At step S20, it is determined whether the pedestrian notices the vehicle. If the pedestrian notices the vehicle, the pedestrian takes the active evasive action. If the pedestrian does not notice the vehicle, the pedestrian walks normally.

At step S30, the hazard zone of vehicle-pedestrian collision is determined corresponding to the case that the pedestrian takes the active evasive action and the case that the pedestrian does not take the active evasive action, respectively. In an embodiment, the active evasive action taken by the pedestrian includes an emergency-stop and moving-backwards evasion or a speeding-up evasion. Of course, based on the core inventive concept of the present disclosure, more evasive actions of the pedestrian may be incorporated in the solutions to determine a more accurate collision hazard zone.

At step S40, it is determined whether the pedestrian is in the range of the collision hazard zone. The determination is made according to the position of the pedestrian detected currently, the position of the vehicle, and the determined range of the collision hazard zone.

At step S50, the hazard of the vehicle-pedestrian collision is evaluated according to a determination whether the pedestrian is in the range of the collision hazard zone. If the pedestrian is not within the range of the collision hazard zone, the hazard of the vehicle-pedestrian collision is relatively low. If the pedestrian is within the range of the collision hazard zone, the hazard of the vehicle-pedestrian collision is relatively high. Specifically, the probability of collision hazard may be determined by combining five different collision hazard zones obtained in the above embodiments. For example, the probability of the collision hazard of the fifth hazard zone is the highest, because when the pedestrian is in the fifth collision hazard zone, no matter what action the vehicle takes, the collision cannot be avoided.

In an embodiment, in the method for evaluating the hazard of vehicle-pedestrian collision, the determining the hazard zone of vehicle-pedestrian collision corresponding to the case that the pedestrian takes the active evasive action and the case that the pedestrian does not take the active evasive action, respectively, further includes following steps.

It is assumed that the vehicle makes an immediate reaction or not. The immediate reaction of the vehicle includes a normal driving of the vehicle and an emergency braking of the vehicle. The emergency braking of the vehicle includes a straight-driving emergency braking and an emergency veering.

The hazard zone of vehicle-pedestrian collision is determined according to a determination whether the pedestrian takes the active evasive action or not and an assumption whether the vehicle makes an immediate reaction or not.

In this embodiment, the specific method for determining the collision hazard zone may be determined by referring to the above steps of the method for determining hazard zone of vehicle-pedestrian collision, and will not be repeated hereinafter.

In an embodiment, in the method for evaluating the hazard of vehicle-pedestrian collision, the step of evaluating the hazard of the vehicle-pedestrian collision according to the determination whether the pedestrian is in the range of the collision hazard zone further includes following steps.

For the pedestrian located in a remaining hazard zone of the first collision hazard zone minus the second collision hazard zone and minus the third collision hazard zone, the hazard of vehicle-pedestrian collision is the first-level hazard. When the hazard of vehicle-pedestrian collision is the first-level hazard, the vehicle may take the active evasive action (braking or veering) or issue an alarm to remind the pedestrian to pay attention to the vehicle and take the active evasive action to evade collision.

For the pedestrian located in a remaining hazard zone of the second collision hazard zone minus the third collision hazard zone and minus the fourth collision hazard zone, the hazard of vehicle-pedestrian collision is the second-level hazard. When the hazard of vehicle-pedestrian collision is the second-level hazard, the vehicle may take the active evasive action (veering) or issue an alarm to remind the pedestrian to pay attention to the vehicle and take the active evasive action to evade collision.

For the pedestrian located in a remaining hazard zone of the third collision hazard zone minus the fourth collision hazard zone, the hazard of vehicle-pedestrian collision is the third-level hazard. When the hazard of vehicle-pedestrian collision is the third-level hazard, the active evasive action of the pedestrian cannot prevent the collision effectively any more, and the collision can be prevented only by means of the active evasion (braking or veering) of the vehicle.

For the pedestrian located in a remaining hazard zone of the fourth collision hazard zone minus the fifth collision hazard zone, the hazard of vehicle-pedestrian collision is the fourth-level hazard. When the hazard of vehicle-pedestrian collision is the fourth-level hazard, the active evasive action of the pedestrian cannot prevent the collision effectively any more, and if the vehicle only takes the braking action, the collision still cannot be prevented, and the collision can be prevented only by means of active veering of the vehicle.

For the pedestrian located in the common hazard zone of the fourth collision hazard zone and the fifth collision hazard zone, the hazard of vehicle-pedestrian collision is the fifth-level hazard. The hazard level of the first-level hazard is the lowest, and the hazard level of the fifth-level hazard is the highest. When the hazard of vehicle-pedestrian collision is the fifth-level hazard, any action taken by the vehicle cannot prevent the collision.

The method for evaluating the hazard of vehicle-pedestrian collision provided in this disclosure describes the active evasive ability of the pedestrian in the dangerous condition, the joint influences of the position, the speed, the active evasive ability of the pedestrian, etc. are taken into account during the generation of the hazard zone of vehicle-pedestrian collision, which makes the identification of the hazard of vehicle-pedestrian collision more fully.

The method for evaluating the hazard of vehicle-pedestrian collision provided in this disclosure, by comprehensively considering the braking and veering abilities of the vehicle and the evasive ability of the pedestrian, provides the method for generating the hazard zone of vehicle-pedestrian collision under multiple operating conditions, which is based on the active evasive ability of the pedestrian. The method for evaluating the hazard of vehicle-pedestrian collision is of great significance for the intelligent vehicles to improve the identification of the pedestrian's hazard, which may effectively improve the safety of the pedestrian and the driving comfort of the vehicle during the vehicle-pedestrian interaction.

Referring to FIG. 9, the present disclosure further provides a system for evaluating a hazard of vehicle-pedestrian collision 100, including: a detecting module 10, an analyzing and determining module 20, a computing module 30, and an evaluating module 40.

The detecting module 10 is configured to detect vehicle information and pedestrian information.

The analyzing and determining module 20 is connected to the detecting module 10. The analyzing and determining module 20 is configured to determine whether the pedestrian notices the vehicle. If the pedestrian notices the vehicle, the pedestrian takes an active evasive action. If the pedestrian does not notice the vehicle, the pedestrian walks normally.

The computing module 30 is connected to the analyzing and determining module 20. The computing module 30 is configured to determine the hazard zone of vehicle-pedestrian collision corresponding to the case that the pedestrian takes the active evasive action and the case that the pedestrian does not take the active evasive action, respectively.

The evaluating module 40 is connected to the computing module 30. The evaluating module 40 is configured to evaluate the hazard of the vehicle-pedestrian collision according to whether the pedestrian is in the range of the collision hazard zone.

In this embodiment, the above-mentioned modules may be realized by relying on computer programs, and specific hardware structures of the modules are not specifically limited, as long as the above-mentioned functions can be realized. The system for evaluating the hazard of vehicle-pedestrian collision 100 provided in this embodiment may perform all steps in the method of evaluating the hazard of vehicle-pedestrian collision. The system for evaluating the hazard of vehicle-pedestrian collision 100 provided in this embodiment, by comprehensively considering the braking and veering abilities of the vehicle and the evasive ability of the pedestrian, provides the method for generating the hazard zone of vehicle-pedestrian collision under multiple operating conditions, which is based on the active evasive ability of the pedestrian. The system for evaluating the hazard of vehicle-pedestrian collision is of great significance for the intelligent vehicles to improve the identification of the pedestrian's hazard, which may effectively improve the safety of the pedestrian and the driving comfort of the vehicle during the vehicle-pedestrian interaction.

The above-mentioned embodiments may be combined arbitrarily. In order to make the description concise, not all possible combinations of the technical features in the above-mentioned embodiments are described. However, as long as there is no contradiction in the combinations of these technical features, these combinations should be considered to be the scope described in this specification.

The embodiments described above are some embodiments of the present disclosure, and the description thereof is relatively specific and detailed, but should not be construed as a limitation on the scope of the invention patent. It should be noted that, for those skilled in the art, several modifications and improvements may be made without departing from the concepts of the present disclosure, and all these modifications and improvements belong to the protection scope of the present disclosure. Accordingly, the scope of protection of the present disclosure should be determined by the appended claims.

1. A method for determining a hazard zone of vehicle-pedestrian collision, comprising:
detecting and outputting vehicle information and pedestrian information;
determining whether the pedestrian notices the vehicle, if the pedestrian notices the vehicle, the pedestrian taking an active evasive action, and if the pedestrian does not notice the vehicle, the pedestrian walking normally;
further assuming that the vehicle makes an immediate reaction or not corresponding to a case that the pedestrian takes the active evasive action and a case that the pedestrian does not take the active evasive action, respectively; and
determining the hazard zone of vehicle-pedestrian collision, according to a determination whether the pedestrian takes the active evasive action or not and an assumption whether the vehicle makes the immediate reaction or not.

2. The method for determining the hazard zone of vehicle-pedestrian collision of claim 1, wherein:
the active evasive action taken by the pedestrian comprises an emergency-stop and moving-backwards evasion, or a speeding-up evasion; and
the determining the hazard zone of vehicle-pedestrian collision according to the determination whether the pedestrian takes the active evasive action or not and the assumption whether the vehicle makes the immediate reaction or not, comprises:
determining time to collision (TTC) safe envelope lines of the vehicle-pedestrian collision hazard in a case that the pedestrian takes the active evasive action; and
further determining the hazard zone of vehicle-pedestrian collision on the basis of the TTC safe envelope lines;
wherein, the determining the TTC safe envelope lines of the vehicle-pedestrian collision hazard comprises:
determining a distance range detected by the vehicle;
calculating a shortest distance required for the pedestrian to safely evade the vehicle according to an emergency-stop and moving-backwards evasion speed of the pedestrian, a speeding-up evasion speed of the pedestrian, and a width of the vehicle;
calculating TTC safety boundaries of the pedestrian according to an initial speed of the pedestrian and the shortest distance required for the pedestrian to evade the vehicle safely; and
calculating the TTC safe envelope lines of the vehicle-pedestrian collision hazard according to a TTC of the vehicle and the TTC safety boundaries of the pedestrian.

3. The method for determining the hazard zone of vehicle-pedestrian collision of claim 1, wherein the determining the hazard zone of vehicle-pedestrian collision according to the determination whether the pedestrian takes the active evasive action or not and the assumption whether the vehicle makes the immediate reaction or not, comprises:
determining a first hazard zone in a case that neither the pedestrian takes the active evasive action nor the vehicle makes an immediate reaction;
determining a second hazard zone in a case that the pedestrian does not take the active evasive action but the vehicle makes an emergency braking;
determining a third hazard zone in a case that the pedestrian takes the active evasive action but the vehicle does not make the immediate reaction; and
determining a fourth hazard zone in a case that the pedestrian takes the active evasive action and the vehicle makes an emergency braking.

4. The method for determining the hazard zone of vehicle-pedestrian collision of claim 3, wherein after the detecting and outputting the vehicle information and the pedestrian information, the method further comprises:
determining a fifth hazard zone in a case that the vehicle makes the emergency braking and makes an emergency veering.

5. The method for determining the hazard zone of vehicle-pedestrian collision of claim 2, wherein the TTC safe envelope lines of the vehicle-pedestrian collision hazard are calculated by using formulas:
$${TTC}_{vr} = \frac{{D}_{vr}}{{v}_{v}} \\ \{ 0 \leq {TTC}_{vd} \leq {TTC}_{vr} \} \\ {D}_{pb - ne} ( {TTC}_{vd} ) = {\int }_{0}^{{TTC}_{vd}} {v}_{pb} ( t ) {d}_{TTC} + \frac{{L}_{vw}}{2} \\ {D}_{pf - fe} ( {TTC}_{vd} ) = {\int }_{0}^{{TTC}_{vd}} {v}_{pf} ( t ) {d}_{TTC} - \frac{{L}_{vw}}{2} \\ {TTC}_{pb - ne} ( {TTC}_{vd} ) = {D}_{pb - ne} ( {TTC}_{vd} ) / {v}_{pw} \\ {TTC}_{pf - fe} ( {TTC}_{vd} ) = {D}_{pf - fe} ( {TTC}_{vd} ) / {v}_{pw} \\ [ {TTC}_{vd} , {TTC}_{pf - fe} ] \leq TTCdangerous - area \leq [ {TTC}_{vd} , {TTC}_{pb - ne} ]$$
wherein: Dᵥᵣ represents a longest distance detected by the vehicle; νᵥ represents a driving speed of the vehicle; TTCᵥᵣ represents a time taken for the vehicle to reach a farthest detection point driving at a current speed; TTC_{vd} represents a time taken for the vehicle to reach a potential collision, and TTC_{vd} is a variable; ν_{pb} represents the emergency-stop and moving-backwards evasion speed of the pedestrian; ν_{pf} represents the speeding-up evasion speed of the pedestrian; D_{pb-ne} represents a shortest distance of the pedestrian away from a near end of the vehicle, which is required for the pedestrian to safely evade the vehicle in a case that the pedestrian takes the emergency-stop and moving-backwards evasive action; TTC_{pf-fe} represents a shortest distance of the pedestrian away from a far end of the vehicle, which is required for the pedestrian to safely evade the vehicle in a case that the pedestrian takes a speeding-up evasive action; L_{vw} represents the width of the vehicle; ν_{pw} represents the initial speed of the pedestrian when the pedestrian starts to take the evasive action; TTC_{pb-ne} represents a shortest time taken for the pedestrian to evade the vehicle in a case that the pedestrian takes an emergency-stop and moving-backwards evasive action; TTC_{pf-ne} represents a shortest time taken for the pedestrian to safely evade the vehicle in the case that the pedestrian takes the speeding-up evasive action; and TTCdangerous−area represents the TTC safe envelope lines of the vehicle-pedestrian collision hazard.

6. The method for determining the hazard zone of vehicle-pedestrian collision of claim 3, wherein, in the case that neither the pedestrian takes the active evasive action nor the vehicle makes the immediate reaction, the first collision hazard zone is determined to be: [Dᵥ₋₁, D_{p-1-fe}]≤the first collision hazard zone≤[Dᵥ₋₁, Dₚ₋₁₋ₙₑ] according to equations:
$${D}_{v - 1} ( {TTC}_{vd} ) = {\int }_{0}^{{TTC}_{vd}} {v}_{v} {d}_{TTC} \\ {D}_{p - 1 - ne} ( {TTC}_{vd} ) = {v}_{pd} \times {TTC}_{vd} + \frac{{L}_{vw}}{2} \\ {D}_{p - 1 - fe} ( {TTC}_{vd} ) = {v}_{pd} \times {TTC}_{vd} - \frac{{L}_{vw}}{2}$$
wherein, νᵥ represents a current driving speed of the vehicle; TTC_{vd} represents a time taken for the vehicle to reach a potential collision point; ν_{pd} represents a current moving speed of the pedestrian detected by the vehicle in an actual motion scene; Dᵥ₋₁ represents a first traveled range of the vehicle in a driving direction within the time TTC_{vd}; L_{vw} represents a width of the vehicle; Dₚ₋₁₋ₙₑ represents a first shortest distance of the pedestrian away from a near end of the vehicle, which is required for the pedestrian to safely evade the vehicle when the pedestrian moves at the speed ν_{pd}; D_{p-1-fe} represents a second shortest distance of the pedestrian away from a far end of the vehicle, which is required for the pedestrian to safely evade the vehicle when the pedestrian moves at the speed ν_{pd}.

7. The method for determining the hazard zone of vehicle-pedestrian collision of claim 3, wherein, in the case that the pedestrian does not take the active evasive action but the vehicle makes the emergency braking, the second collision hazard zone is determined to be: [Dᵥ₋₂, D_{p-2-fe}]≤the second collision hazard zone≤[Dᵥ₋₂, Dₚ₋₂₋ₙₑ] according to equations:
$${D}_{v - 2} ( {TTC}_{vd} ) = {\int }_{0}^{{v}_{v} / {a}_{vx - max}} {v}_{v} + {a}_{vx - max} \times {TTC}_{vd} {d}_{TTC} \\ {D}_{p - 2 - ne} ( {TTC}_{vd} ) = {v}_{pd} \times {TTC}_{vd} + \frac{{L}_{vw}}{2} \\ {D}_{p - 2 - fe} ( {TTC}_{vd} ) = {v}_{pd} \times {TTC}_{vd} - \frac{{L}_{vw}}{2}$$
wherein, νᵥ represents a current driving speed of the vehicle; TTC_{vd} represents a time taken for the vehicle to reach a potential collision point; ν_{pd} represents a current moving speed of the pedestrian detected by the vehicle in an actual motion scene; aᵥₓ₋ₘₐₓ represents a maximum braking deceleration of the vehicle; Dᵥ₋₂ represents a second traveled range of the vehicle in a driving direction within the time TTC_{vd}; L_{vw} represents a width of the vehicle; Dₚ₋₂₋ₙₑ represents a third shortest distance of the pedestrian away from a near end of the vehicle, which is required for the pedestrian to safely evade the vehicle when the pedestrian moves at the speed ν_{pd}; D_{p-2-fe} represents a fourth shortest distance of the pedestrian away from a far end of the vehicle, which is required for the pedestrian to safely evade the vehicle when the pedestrian moves at the speed ν_{pd}.

8. The method for determining the hazard zone of vehicle-pedestrian collision of claim 3, wherein, in the case that the pedestrian takes the active evasive action but the vehicle does not make the immediate reaction, the third collision hazard zone is determined to be: [Dᵥ₋₃, D_{p-3-BA-ne}]≤the third collision hazard zone≤[Dᵥ₋₃, D_{p-3-FA-fe}] according to equations:
$${D}_{v - 3} ( {TTC}_{vd} ) = {\int }_{0}^{{TTC}_{vd}} {v}_{v} {d}_{TTC} \\ {D}_{p - 3 - ne} ( {TTC}_{vd} ) = {v}_{pd} ( {TTC}_{vd} ) \times {TTC}_{pb - ne} ( {TTC}_{vd} ) + \frac{{L}_{vw}}{2} \\ {D}_{p - 3 - fe} ( {TTC}_{vd} ) = {v}_{pd} ( {TTC}_{vd} ) \times {TTC}_{pf - fe} ( {TTC}_{vd} ) - \frac{{L}_{vw}}{2}$$
wherein, νᵥ represents a current driving speed of vehicle; TTC_{vd} represents a time taken for the vehicle to reach a potential collision point; ν_{pd} represents a current moving speed of the pedestrian detected by the vehicle in an actual motion scene; TTC_{pb-ne} represents a shortest time taken for the pedestrian to evade the vehicle in a case that the pedestrian takes an emergency-stop and moving-backwards evasive action; TTC_{pf-ne} represents a shortest time taken for the pedestrian to safely evade the vehicle in a case that the pedestrian takes a speeding-up evasive action; L_{vw} represents a width of the vehicle; D_{ν-3} represents a third traveled range of the vehicle in a driving direction within the time TTC_{vd}; Dₚ₋₃₋ₙₑ represents a fifth shortest distance of the pedestrian away from a near end of the vehicle, which is required for the pedestrian to safely evade the vehicle when the pedestrian moves at the speed ν_{pd}; D_{p-3-fe} represents a sixth shortest distance of the pedestrian away from a far end of the vehicle, which is required for the pedestrian to safely evade the vehicle when the pedestrian moves at the speed ν_{pd}.

9. The method for determining the hazard zone of vehicle-pedestrian collision of claim 3, wherein, in the case that the pedestrian takes the active evasive action and the vehicle makes the emergency braking, the fourth collision hazard zone is determined to be: [Dᵥ₋₄, Dₚ₋₄₋ₙₑ]≤the fourth collision hazard zone≤[Dᵥ₋₄, D_{p-4-fe}] according to equations:
$${D}_{v - 4} ( {TTC}_{vd} ) = {\int }_{0}^{{v}_{v} / {a}_{vx - max}} {v}_{v} + {a}_{vx - max} \times {TTC}_{vd} {d}_{TTC} \\ {D}_{p - 4 - ne} ( {TTC}_{vd} ) = {v}_{pd} ( {TTC}_{vd} ) \times {TTC}_{pb - ne} ( {TTC}_{vd} ) + \frac{{L}_{vw}}{2} \\ {D}_{p - 4 - fe} ( {TTC}_{vd} ) = {v}_{pd} ( {TTC}_{vd} ) \times {TTC}_{pf - fe} ( {TTC}_{vd} ) - \frac{{L}_{vw}}{2}$$
wherein, νᵥ represents a current driving speed of the vehicle; TTC_{vd} represents a time taken for the vehicle to reach a potential collision point; ν_{pd} represents a current moving speed of the pedestrian detected by the vehicle in an actual motion scene; aᵥₓ₋ₘₐₓ represents a maximum braking deceleration of the vehicle; TTC_{pb-ne} represents a shortest time taken for the pedestrian to evade the vehicle in a case that the pedestrian takes an emergency-stop and moving-backwards evasive action; TTC_{pf-ne} represents a shortest time taken for the pedestrian to safely evade the vehicle in a case that the pedestrian takes a speeding-up evasive action; L_{vw} represents a width of the vehicle; Dᵥ₋₄ represents a fourth traveled range of the vehicle in a driving direction within the time TTC_{vd}; Dₚ₋₄₋ₙₑ represents a seventh shortest distance of the pedestrian away from a near end of the vehicle, which is required for the pedestrian to safely evade the vehicle when the pedestrian moves at the speed ν_{pd}; D_{p-4-ef} represents an eighth shortest distance of the pedestrian away from a far end of the vehicle, which is required for the pedestrian to safely evade the vehicle when the pedestrian moves at the speed ν_{pd}.

10. The method for determining the hazard zone of vehicle-pedestrian collision of claim 3, wherein in the case that the vehicle makes the immediate reaction, the immediate reaction of the vehicle comprises a normal driving of the vehicle, a straight-driving emergency braking of the vehicle, and an emergency veering of the vehicle;
determining a braking distance of the vehicle according to a current driving speed of the vehicle and a maximum braking deceleration of the vehicle when the immediate reaction made by the vehicle is the straight-driving emergency braking of the vehicle; and
determining a minimum turning radius of the vehicle according to the current driving speed of the vehicle and a maximum lateral acceleration of the vehicle when the immediate reaction made by the vehicle is the emergency veering of the vehicle.

11. The method for determining the hazard zone of vehicle-pedestrian collision of claim 10, wherein in a case that the vehicle makes the immediate reaction, the braking distance D_{vb} of the vehicle and the minimum turning radius R_{vd-min} for a stability of the vehicle are calculated with reference to equations:
D_{vb}=(νᵥ)²/2aᵥₓ₋ₘₐₓ
wherein νᵥ represents a current driving speed of the vehicle, and aᵥₓ₋ₘₐₓ represents a maximum braking deceleration of the vehicle; and
Rᵥ₋ₘᵢₙ=νᵥ/wᵥ
wᵥ=νᵥ/a_{vy-max}, (R_{vd-min}≥Rᵥ₋ₘᵢₙ)
wherein wᵥ represents a yaw velocity of the vehicle, Rᵥ₋ₘᵢₙ represents the minimum turning radius of the vehicle, and a_{vy-max} represents a maximum lateral acceleration.

12. The method for determining the hazard zone of vehicle-pedestrian collision of claim 11, wherein in the case that the vehicle makes the emergency braking and the emergency veering, a fifth hazard zone of the vehicle-pedestrian collision is determined to be: [Dᵥ₋₅, D_{vl-5-fe}]≤the fifth collision hazard zone≤[D_{V-5}, Dᵥₗ₋₅₋ₙₑ] according to equations:
$${D}_{v - 5} ( {TTC}_{vd} ) = {\int }_{0}^{{v}_{v} / {a}_{vx - max}} {v}_{v} + {a}_{vx - max} \times {TTC}_{vd} {d}_{TTC} \\ {v}_{vb} ( {TTC}_{vd} ) = {v}_{v} + {a}_{vx - max} \times {TTC}_{vd} \\ {R}_{vb} ( {TTC}_{vd} ) = {( {v}_{vb} ( {TTC}_{vd} ) )}^{2} / {a}_{vy - max} \\ {A}_{vs} ( {TTC}_{vd} ) = {tan}^{- 1} \sum \frac{Δ {D}_{v - 5}}{{R}_{vb} ( {TTC}_{vd} )} \\ {D}_{vl - 5 - ne} ( {TTC}_{vd} ) = {\sum }_{0}^{{TTC}_{vd}} ( Δ {D}_{v - 5} \times sin {A}_{vs} ( {TTC}_{vd} ) ) + \frac{{L}_{vw}}{2} \\ {D}_{vl - 5 - fe} ( {TTC}_{vd} ) = {\sum }_{0}^{{TTC}_{vd}} ( Δ {D}_{v - 5} \times sin {A}_{vs} ( {TTC}_{vd} ) ) - \frac{{L}_{vw}}{2}$$
wherein, νᵥ represents the current driving speed of the vehicle. ν_{vb} represents a speed of the vehicle in a process of braking; aᵥₓ₋ₘₐₓ represents the maximum braking deceleration of the vehicle; a_{vy-max} represents the maximum lateral acceleration of the vehicle; TTC_{vd} represents a time taken for the vehicle to reach a potential collision point; Aᵥₛ represents an accumulated turning angle in a process of veering; Dᵥ₋₅ represents a fifth traveled range of the vehicle in a driving direction within the time TTC_{vd}; D_{p-5-n e} represents a ninth shortest distance of the pedestrian away from a near end of the vehicle, which is required for the pedestrian to safely evade the vehicle when the pedestrian moves at the speed ν_{pd}; D_{p-5-fe} represents a tenth shortest distance of the pedestrian away from a far end of the vehicle, which is required for the pedestrian to safely evade the vehicle when the pedestrian moves at the speed ν_{pd}.

13. A method for evaluating a hazard of vehicle-pedestrian collision comprising:
detecting and outputting vehicle information and pedestrian information;
determining whether the pedestrian notices the vehicle, if the pedestrian notices the vehicle, the pedestrian taking an active evasive action, and if the pedestrian does not notice the vehicle, the pedestrian walking normally;
determining a hazard zone of vehicle-pedestrian collision corresponding to a case that the pedestrian takes the active evasive action and a case that the pedestrian does not take the active evasive action, respectively;
determining whether the pedestrian is in a range of the collision hazard zone; and
evaluating the hazard of vehicle-pedestrian collision according to a determination whether the pedestrian is in the range of the collision hazard zone.

14. The method for evaluating the hazard of vehicle-pedestrian collision of claim 13, wherein, the determining the hazard zone of vehicle-pedestrian collision corresponding to the case that the pedestrian takes the active evasive action and the case that the pedestrian does not take the active evasive action, respectively, further comprises:
assuming the vehicle makes an immediate reaction or not; and
determining the hazard zone of vehicle-pedestrian collision according to a determination whether the pedestrian takes the active evasive action or not and an assumption whether the vehicle makes the immediate reaction or not.

15. The method for evaluating the hazard of vehicle-pedestrian collision of claim 14, wherein:
the active evasive action taken by the pedestrian comprises an emergency-stop and moving-backwards evasion, or a speeding-up evasion; and
the determining the hazard zone of vehicle-pedestrian collision according to the determination whether the pedestrian takes the active evasive action or not and the assumption whether the vehicle makes the immediate reaction or not, comprises:
determining time to collision (TTC) safe envelope lines of the vehicle-pedestrian collision hazard in a case that the pedestrian takes the active evasive action; and
further determining the hazard zone of vehicle-pedestrian collision on the basis of the TTC safe envelope lines;
wherein, the determining the TTC safe envelope lines of the vehicle-pedestrian collision hazard comprises:
determining a distance range detected by the vehicle;
calculating a shortest distance required for the pedestrian to safely evade the vehicle according to an emergency-stop and moving-backwards evasion speed of the pedestrian, a speeding-up evasion speed of the pedestrian, and a width of the vehicle;
calculating TTC safety boundaries of the pedestrian according to an initial speed of the pedestrian and the shortest distance required for the pedestrian to evade the vehicle safely; and
calculating the TTC safe envelope lines of the vehicle-pedestrian collision hazard according to a TTC of the vehicle and the TTC safety boundaries of the pedestrian.

16. The method for evaluating the hazard of vehicle-pedestrian collision of claim 14, the determining the hazard zone of vehicle-pedestrian collision according to the determination whether the pedestrian takes the active evasive action or not and the assumption whether the vehicle makes the immediate reaction or not, comprises:
determining a first hazard zone in a case that neither the pedestrian takes the active evasive action nor the vehicle makes an immediate reaction;
determining a second hazard zone in a case that the pedestrian does not take the active evasive action but the vehicle makes an emergency braking;
determining a third hazard zone in a case that the pedestrian takes the active evasive action but the vehicle does not make the immediate reaction;
determining a fourth hazard zone in a case that the pedestrian takes the active evasive action and the vehicle makes an emergency braking; and
determining a fifth hazard zone in a case that the vehicle makes an emergency braking and the vehicle makes an emergency veering.

17. The method for evaluating the hazard of vehicle-pedestrian collision of claim 16, wherein the evaluating the hazard of the vehicle-pedestrian collision according to a determination whether the pedestrian is in the range of the collision hazard zone comprises:
the hazard of vehicle-pedestrian collision being a first-level hazard for the pedestrian located in a remaining hazard zone of the first collision hazard zone minus the second collision hazard zone and minus the third collision hazard zone;
the hazard of vehicle-pedestrian collision being a second-level hazard for the pedestrian located in a remaining hazard zone of the second collision hazard zone minus the third collision hazard zone and minus the fourth collision hazard zone;
the hazard of vehicle-pedestrian collision being a third-level hazard for the pedestrian located in a remaining hazard zone of the third collision hazard zone minus the fourth collision hazard zone;
the hazard of vehicle-pedestrian collision being the fourth-level hazard for the pedestrian located in a remaining hazard zone of the fourth collision hazard zone minus the fifth collision hazard zone; and
the hazard of vehicle-pedestrian collision being a fifth-level hazard for the pedestrian located in the common hazard zone of the fourth collision hazard zone and the fifth collision hazard zone.

18. A system for evaluating a hazard of vehicle-pedestrian collision, comprising:
a detecting module, configured to detect vehicle information and pedestrian information;
an analyzing and determining module, connected to the detecting module and configured to determine whether the pedestrian notices the vehicle, wherein if the pedestrian notices the vehicle, the pedestrian takes an active evasive action, and if the pedestrian does not notice the vehicle, the pedestrian walks normally;
a computing module, connected to the analyzing and determining module and configured to determine the hazard zone of vehicle-pedestrian collision corresponding to the case that the pedestrian takes the active evasive action and the case that the pedestrian does not take the active evasive action, respectively; and
an evaluating module, connected to the computing module and configured to evaluate the hazard of the vehicle-pedestrian collision according to whether the pedestrian is in a range of the collision hazard zone.
